(19) United States
(12) Patent Application Publication
(10) Pub. No.: US 2011/0218260 A1
(43) Pub. Date: Sep. 8, 2011

(54) Mixed Glycol Polyphosphonate Compounds

(75) Inventors: Arthur G. Mack, Prairieville, LA (US); Techen Tsao, Baton Rouge, LA (US)

(73) Assignee: ALBEMARLE CORPORATION, Baton Rouge, LA (US)

(21) Appl. No.: 13/120,305

(22) PCT Filed: Oct. 20, 2009
(86) PCT No.: PCT/US09/61241

§ 371 Date: Mar. 22, 2011

Related U.S. Application Data
(60) Provisional application No. 61/107,010, filed on Oct. 21, 2008.

(51) Int. Cl. C08K 5/5333; C07F 9/06; C08J 9/35; C08L 75/08

(52) U.S. Cl. 521/108; 558/156; 558/89; 524/131

(57) ABSTRACT

New highly-effective non-halogen, low VOC, low fogging, and cost-effective oligomeric polyphosphonate flame retardants for flexible polyurethane foams as well as for other flame retardant applications are described. In addition, methods for the preparation and uses of such new highly effective flame retardants are described. Formula (I)

### TECHNICAL FIELD

This invention relates to new polyphosphonate compounds, their preparation and uses for such compounds.

### BACKGROUND

Over the years, considerable efforts have been directed toward trying to develop effective non-halogen, low VOC (volatile organic compounds), low fogging, and cost-effective flame retardants for flexible polyurethane foams. Such foams are very useful in automotive and furniture applications. Organic compounds which evaporate readily to the atmosphere (i.e., VOC's) are known to contribute to photochemical smog production and are often subject to certain health, safety, and environmental concerns.

Commonly-owned International Publication Number WO 2008/073871 A1 describes certain organophosphonate oligomers capable of providing flame retarded polyurethane foams of very desirable quality.

It is known that alkyl phosphonate oligomer, with an alkyleneoxy linkage prepared from phosphite oligomer having alkyleneoxy linkage, have high water solubility. The water solubility increases the breakdown of oligomer backbone during the high temperature processing and thus limits the applications in some polymer systems.

It would be of advantage if a way could be found of providing new highly-effective non-halogen, low VOC, low fogging, and cost-effective flame retardants for flexible polyurethane foams as well as for other flame retardant applications, and methods for the preparation and use of such new highly effective flame retardants.

This invention is deemed to provide new flame retardants, new processes for their preparation, and new compositions and processes involving their use, thereby achieving most, if not all, of the foregoing advantages. In addition, new flame retardants of this invention have reduced water solubility characteristics.

### BRIEF NON-LIMITING SUMMARY OF THE INVENTION

This invention provides processes for preparing, and compositions of, certain oligomeric organic phosphonates of new chemical structures. Also provided by this invention are new compositions and new processes in which such novel oligomeric organic phosphonates are used.

The new oligomeric organic phosphonates of this invention are comprised of at least one oligomeric organic phosphonate represented by the formula:

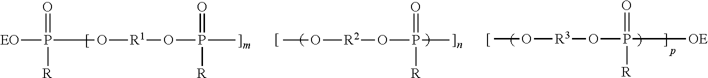

wherein:
each R can be the same or different and is a benzyl group or a C₁₋₄ primary or secondary alkyl group, and of the total number of R groups in the molecule, (i) each one is a benzyl group, or (ii) each one is a C₁₋₄ primary or secondary alkyl group (which can differ from each other but which preferably are all are the same C₁₋₄ primary or secondary alkyl group), or (iii) at least one of them is a benzyl group and at least one of them is a C₁₋₄ primary or secondary alkyl group;
each R¹ can be the same or different, and is (i) an alkylene group having 2 to 6 carbon atoms, (ii) an alkyleneoxyalkylene group, in which each alkylene moiety contains, independently, 2 or 3 carbon atoms, or (iii) an alkyleneoxyalkyleneoxyalkylene group in which each alkylene moiety contains, independently, 2 or 3 carbon atoms;
each R² can be the same or different, and is (i) a 1,3-phenylene group, (ii) a 1,4-phenylene group, (iii) a -ph-O-ph- group in which ph is a 1,4-phenylene group, (iv) a -ph-O-ph-O-ph- group in which ph is a 1,4-phenylene group, (v) a -al-O-ph-O-al- group in which al is an ethylene group and ph is a 1,4-phenylene group, or a (vi) a -ph-R⁴-ph- group in which each ph is a 1,4-phenylene group and R⁴ is a 2,2-propylidene group;
each R³ can be the same or different, and is (i) a -cy- group which is an unsubstituted cycloalkylene group, typically containing five to eight carbon atoms in the ring, and preferably is a 1,4-cyclohexylene group, (ii) a -cy-alk- group in which cy is a cycloalkylene group, typically containing five to eight carbon atoms in the ring, preferably a 1,4-cyclohexylene group, and alk is a methylene group, an ethylene group or a 1,3-propylene group, (iii) a -alk-cy-alk- group in which cy is a cycloalkylene group, typically containing five to eight carbon atoms in the ring, preferably a 1,4-cyclohexylene group, and alk is a methylene or ethylene group;
m is an integer in the range of 0 to 5, n is an integer in the range of 0 to 5, and p is an integer in the range of 0 to 5, with the total of said integers m, n, and p being in the range of 3 to 10, and with the provisos that only one of m, n and p can be 0, and that neither m nor n nor p need be 0; and
each E is independently selected from HOR¹O—, HOR²O—, HO—R³O— or lower alkyl; and
   wherein the bracketed segments of m, n, and p can be arranged in any order or sequence such that the oligomer has a random configuration, an alternating configuration, or a block configuration.

A few non-limiting examples of R¹ groups of the above formula are:

—C₄H₉—, —C₆H₁₂—, —CH₂CH₂OCH₂CH₂—, —CH₂CH₂OCH₂CH₂OCH₂CH₂—, —C₃H₆OC₃H₆—

A few non-limiting examples of R² groups of the above formula are:

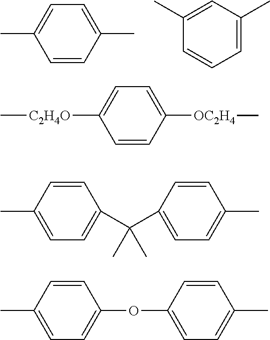

Similarly R³ groups of the above formula are illustrated by the following non-limiting groups:

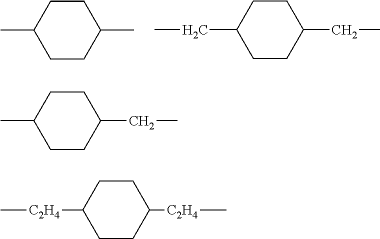

It is to be understood that the formulas given herein are not intended to limit the compounds to any particular stereochemical (spatial) configurations.

It can be seen from the above formula that the oligomeric organic phosphonates of this invention must contain at least 2 different segments selected from 3 types of segments, namely:
(1) particular types of alkylene or alkylene-containing groups as specified above, i.e., those containing R¹;
(2) particular types of phenylene or phenylene-containing groups as specified above, i.e., those containing R²;
(3) particular types of cycloalkylene or cycloalkylene-containing groups as specified above, i.e., those containing R³.
   It is also to be noted that the oligomeric organophosphonate can contain at least one of all three of the above types of segments. Further, the oligomeric organophosphonate can contain in the molecule more than one R¹-type of segment, which, as indicated above, can be the same or different from each other; and/or more than one R²-type of segment, which, as indicated above, can be the same or different from each other; and/or more than one R³-type of segment in the molecule, which, as indicated above, can be the same or different from each other. The actual make-up of the molecule depends upon the number of different diols or diphenols used in producing the backbone of the oligomeric phosphonate.

In order to prepare oligomeric phosphites, it is generally known that a catalyst, such as sodium methoxide, is needed to perform this transesterification. Such catalyst may have an adverse tendency of defragmenting the segments of the oligomer and thus result in higher VOC. In accordance with this invention, it was found that oftentimes such a transesterification catalyst is unnecessary. However, the use of a suitable transesterification catalyst is within the scope of the present invention. Non-limiting examples of suitable transesterification catalysts include, for example, sodium carbonate, potassium carbonate, sodium methoxide, and potassium methoxide.

It was also generally known that alkyl halides are generally required as catalysts to effect conversion of phosphite esters to phosphonates. In accordance with this invention, it was found that using a mixture of diols comprised of at least 14% of an aromatic diol resulted in formation of a phosphite oligomer which can be converted to a phosphonate oligomer simply by heating without using a catalyst. It appears that this type of reaction has not been reported in the prior art.

### FURTHER DETAILED DESCRIPTION OF EMBODIMENTS OF THIS INVENTION

The oligomeric organic phosphonate flame retardants of this invention can be prepared by a process which comprises:

I) bringing together at least one tri-lower alkyl phosphite, and at least two dihydroxy compounds selected from:
A) aliphatic diols of the formula HO—R¹—OH in which each R¹ is (i) an alkylene group having 2 to 6 carbon atoms, (ii) an alkyleneoxyalkylene group, in which each alkylene moiety contains, independently, 2 or 3 carbon atoms, or (iii) an alkyleneoxyalkyleneoxyalkylene group in which each alkylene moiety contains, independently, 2 or 3 carbon atoms, and when more than one R′-containing segment is present in the molecule the R¹ groups can be the same or different from each other;
B) diphenolic compounds of the formula HO—R²—OH in which R² is (i) a 1,3-phenylene group, (ii) a 1,4-phenylene group, (iii) a -ph-O-ph- group in which ph is a 1,4-phenylene group, (iv) a -ph-O-ph-O-ph- group in which ph is a 1,4-phenylene group, (v) a -al-O-ph-O-al- group in which al is an ethylene group and ph is a 1,4-phenylene group, or a (vi) a -ph-R⁴-ph- group in which each ph is a 1,4-phenylene group and R⁴ is a 2,2-propylidene group; and when more than one R²-containing segment is present in the molecule the R² groups can be the same or different from each other;
C) cycloaliphatic diols of the formula HO—R³—OH in which R³ is (i) a -cy- group in which cy is an unsubstituted cycloalkylene group, preferably a 1,4-cyclohexylene group, (ii) a -cy-al- group in which cy is a cycloalkylene group, preferably a 1,4-cyclohexylene group, and al is a methylene group, an ethylene group or a 1,3-propylene group, (iii) a -al-cy-al- group in which cy is a cycloalkylene group, preferably a 1,4-cyclohexylene group, and al is a methylene or ethylene group; and when more than one R³-containing segment is present in the molecule the R³ groups can be the same or different from each other to form a first reaction mixture, and heating the first reaction mixture at a temperature in the range of about 70 to about 150° C., and removing alkanol from the first reaction mixture to form a first reaction product mixture; and
   II) bringing together first reaction product mixture and (a) at least one alkyl halide, (b) at least one benzyl halide, or (c) a combination of (a) and (b) to form a second reaction mixture, and heating the second reaction mixture at a temperature in the range of about 90 to about 160° C. to form at least one oligomeric organic phosphonate.

In the first stage of this process, i.e., I) above, a tri-lower-alkyl phosphite and a mixture of suitable diols of types A), B), and C) above—i.e., a combination of types A) and B), a combination of types B) and C), a combination of types A) and C), or a combination of types A), B), and C)—are brought together in any manner or sequence, such as by adding either the phosphite to the diols, by adding the diols to the phosphite, or by co-feeding the phosphite and the diols into a reactor and heating them at a temperature in the range of about 70 to about 150° C., and preferably in the range of about 90 to about 130° C. A suitable catalyst such as an alkali metal alkoxide (e.g., a sodium alkoxide such as sodium methoxide) can be used, if desired. During the reaction, a lower alcohol is evolved and should be removed from the reaction zone. Distillation using reduced pressures, if desired, is an effective way of effecting the removal of the alcohol from the reaction mixture. This leaves, in the reaction zone, a first reaction mixture which is then further reacted in the second stage (i.e., II) above).

The proportions of the tri-lower-alkyl phosphite(s) and combination of two or more diols of the types specified above should be such as to utilize a tri-lower-alkyl phosphite(s):diol(s) molar ratio in the range of about 1.1:1 to about 1.5:1, and preferably in the range of about 1.2:1 to about 1.3:1.

As used herein, including the claims, the term “lower-alkyl” means an alkyl group having in the range of 1 to 4 carbon atoms. Thus, the alkyl groups of the tri-lower-alkyl phosphite used in the first stage reaction can each contain, independently, in the range of 1 to 4 carbon atoms. Non-limiting examples of such phosphites include trimethylphosphite, triethylphosphite, tripropylphosphite, triisopropylphosphite, tri-n-butylphosphite, triisobutylphosphite, tri-sec-butylphosphite, tri-tert-butylphosphite, ethyldimethylphosphite, ethyldibutylphosphite, methylethylpropylphosphite, and analogous compounds in which each alkyl group is as defined herein.

There are three types of diols that can be used in the practice of this invention represented above by A), B), and C). Type A) are saturated aliphatic diols which can be diols represented by the formulas HO-al-OH, HO-al-O-al-OH, HO-al-O-al-O-al-OH, where the al groups are the same or different and are alkylene (e.g., —C₂H₄—, —C₃H₆—, —C₄H₈—) groups containing in the range of 2 to 6 carbon atoms. Mixtures of type A) diols can be used. A few non-limiting examples of Type A) diols include 1,2-ethanediol; 1,3-propanediol; 1,4-butanediol; 1,5-pentanediol; 1,6-hexanediol ; diethylene glycol; dipropylene glycol; triethylene glycol; tripropylene glycol; 2-methyl-1,3-propanediol; and analogous aliphatic diols.

Type B) diols are diphenolic compounds which can be considered to be aromatic diols, that is diols in which at least one aromatic hydrocarbyl group is present in the molecule. The type B) diols can thus be represented by the formulas HO-ar-OH, HO-ar-O-ar-OH, HO-ar-O-ar-O-ar-OH, HO-al-O-ar-OH, HO-al-O-ar-O-al-OH, where “al” is a saturated divalent saturated aliphatic hydrocarbon group of 2 to 6 carbon atoms and “ar” is an aromatic hydrocarbon group having 6-18 carbon atoms. Mixtures of type B) diols can be used. A few non-limiting examples of such aromatic diols include resorcinol, hydroquinone, p,p′-biphenol, methylenebisphenol, methylenebis(2-methylphenol), methylenebis(2,5-dimethylphenol), bisphenol-A (a.k.a. 4,4′-isopropylidenediphenol), 4,4′-ethylidenebisphenol, and analogous aromatic diols.

Type C) diols are saturated cycloaliphatic diols which can be represented by the formulas HO-(cy)-OH, HO-(cy)-alk-OH and HO-alk-(cy)-alk-OH, where alk is a saturated aliphatic hydrocarbon group having in the range of 1 to 4 carbon atoms and (cy) is a saturated cycloaliphatic hydrocarbon group having in the range of 5 to 10 carbon atoms. Mixtures of type C) diols can be used. A few non-limiting examples of type C) diols include 1,3-cyclopentanediol, 1,3-cyclohexanediol, 1,4-cyclohexanediol, cis-1,5-cyclooctanediol, 2-(hydroxymethyl)cyclopentanol, 4-(hydroxymethyl)cyclohexanol, 4-(hydroxyethyl)-cyclohexanol, 1,3-cyclopentanedimethanol, 1,3-cyclohexanedimethanol, 1,4-cyclohexane-dimethanol, and analogous cycloaliphatic diols.

In the second stage of this process, i.e., II) above, the first reaction product mixture and at least one alkylhalide or at least one benzylhalide or a combination of alkylhalides and benzylhalides are brought together usually by adding the alkyl and/or benzyl halides to the first reaction product mixture, although other modes of bringing these reactants together can be used, if desired. This resultant reaction mixture is heated at a temperature in the range of about 90 to about 160° C., and preferably in the range of about 100 to about 150° C., to form the oligomeric phosphonate flame retardant product of this invention. Optionally, on completion of the second stage reaction, an epoxide such as ethylene oxide, propylene oxide, 1,2-butylene oxide, 2,3-butylene oxide, or the like can be added to the flame retardant product so as to neutralize any acid generated in the preceding reaction which would result in generation of a hydroxyalkyl group. Whether or not the epoxide reactant is employed, the desired product of the reaction is then recovered, such as by use of vacuum distillation at a suitable elevated temperature. Such temperatures should not exceed about 150° C., as temperatures above this range may tend to induce thermal degradation of the desired product. Thus, distillation temperatures in the range of about 90 to about 140° C. are typically used with suitably reduced pressures in the range of about 10 mm to about 1 mm.

The alkyl halides used in the second stage reaction typically contain in the range of 1 to about 7 carbon atoms and are usually alkyl bromides or chlorides because of suitable reactivity, ready availability, and lower cost. However, other alkyl halides can be used, if desired. The benzyl halides can be substituted on the ring by lower alkyl groups, but preferably are unsubstituted. Benzyl chloride and benzyl bromide are the preferred benzyl halides, again because of suitable reactivity, ready availability, and lower cost. However, other benzyl halides can be used, if desired.

Additional Characteristics of the Oligomeric Flame Retardants of this Invention

The hydroxyl number and the phosphorus content of the oligomeric flame retardants of this invention can be determined by any well-known standard analytical procedure. Typically, the oligomeric flame retardants of this invention will have hydroxyl numbers in the range of about 10 to about 150 and phosphorus contents in the range of about 10 to about 20 wt %. Preferred oligomeric flame retardants of this invention have acid numbers in the range of about 0.01 to about 1 and phosphorus contents in the range of about 14 to about 18 wt %.

The oligomeric flame retardants of this invention are typically viscous liquids which avoid concerns relating to volatile organic compounds (VOC). In addition they are readily compounded with other components in forming flame retardant formulations or mixtures with substrate polymers or resins to be flame retarded. Generally speaking, the viscosities of the oligomeric flame retardants of this invention as determined at 25° C. are in the range of about 1,000 to about 15,000 cps. Preferred oligomeric flame retardants of this invention have viscosities in the range of about 2,000 to about 10,000 cps at 25° C.

In a process where an epoxide is used to end cap portions of the polyphosphonate oligomers with terminal hydroxyl group functionality, the hydroxyl number of the resultant product can be readily determined by use of well-known conventional analytical procedures. Typically, such end capped polyphosphonate oligomers of this invention will have hydroxyl numbers in the range of about 40 to about 100.

Illustrative Uses for the Polyphosphonate Oligomers of this Invention

The polyphosphonate oligomers of this invention are useful as flame retardants in a variety of applications. For example, the polyphosphonate oligomers of this invention are useful as flame retarding agents in polyurethane foams. To form flame retarded polyurethane foams pursuant to this invention, the fundamental components used are isocyanates, polyols, and a polyphosphonate oligomer of this invention. The polyols are polyether polyols or polyester polyols. The reaction readily occurs at room temperature in the presence of a blowing agent such as water, a volatile hydrocarbon, halocarbon, or halohydrocarbon, or mixtures of two or more such materials. Catalysts used in effecting the reaction include amine catalysts, tin-based catalysts, bismuth-based catalysts or other organometallic catalysts, and the like. Surfactants such as substituted silicone compounds are often used in order to maintain homogeneity of the cells in the polymerization system. Hindered phenolic antioxidants, e.g., 2,6-di-tert-butyl-para-cresol and methylenebis(2,6-di-tert-butylphenol), can be used to further assist in stabilization against oxidative degradation. These and other ingredients that can be used, and the proportions and manner in which they are used are reported in the literature. See for example: Herrington and Hock, Flexible Polyurethane Foams, The Dow Chemical Company, 1991, 9.25-9.27 or Roegler, Slabstock Foams; in Polyurethane Handbook; Oertel, G., Ed., Hanser Publishers, Munich, 1985, 176-177; or Woods, G., Flexible Polyurethane Foams, Chemistry and Technology; Applied Science Publishers, London, 1982, 257-260.

In forming flame retarded polyurethanes using a polyphosphonate oligomer formed pursuant to this invention, amounts of the polyphosphonate oligomer of this invention in the range of about 4 to about 15 wt % based on the total weight of the polyurethane formulation, are typically used. Variations from these proportions can be used whenever deemed necessary or desirable without departing from the scope of this invention.

The polyphosphonate oligomer products of this invention are typically pale yellow or slightly off-white in color. Light color is advantageous as it simplifies the end-users' task of insuring consistency of color in the articles that are flame retarded with the oligomeric products.

The polyphosphonate oligomers of this invention can also be used as flame retardants in, or in connection with, polyurethane resins and composites, rigid polyurethane foams, phenolic resins, paints, varnishes, and textiles.

Further, the polyphosphonate oligomers of this invention can be used as additive flame retardants in formulations with other flammable materials. The flammable material may be macromolecular, for example, a cellulosic material or a polymer. Illustrative polymers are: olefin polymers, cross-linked and otherwise, for example homopolymers of ethylene, propylene, and butylene; copolymers of two or more of such alkene monomers and copolymers of one or more of such alkene monomers and other copolymerizable monomers, for example, ethylene/propylene copolymers, ethylene/ethyl acrylate copolymers and ethylene/propylene copolymers, ethylene/acrylate copolymers and ethylene/vinyl acetate copolymers; polymers of olefinically unsaturated monomers, for example, polystyrene, e.g., high impact polystyrene, and styrene copolymers; polyamides; polyimides; polycarbonates; polyethers; acrylic resins; polyesters, especially poly(ethylene terephthalate) and poly(butylene terephthalate); thermosets, for example, epoxy resins; elastomers, for example, butadiene/styrene copolymers and butadiene/acrylonitrile copolymers; terpolymers of acrylonitrile, butadiene and styrene; natural rubber; butyl rubber and polysiloxanes. The polymer may, where appropriate, be cross-linked by chemical means or by irradiation. The polyphosphonate oligomer products of this invention also can be used in textile applications, such as in latex-based back coatings.

The amount of a polyphosphonate oligomer of this invention used in a formulation will be that quantity needed to obtain the flame retardancy sought. It will be apparent to those skilled in the art that for all cases no single precise value for the proportion of the product in the formulation can be given, since this proportion will vary with the particular flammable material, the presence of other additives and the degree of flame retardancy sought in any give application. Further, the proportion necessary to achieve a given flame retardancy in a particular formulation will depend upon the shape of the article into which the formulation is to be made, for example, electrical insulation, tubing, electronic cabinets and film will each behave differently. In general, however, the formulation, and resultant product, may contain in the range of about 1 to about 30 wt %, preferably in the range of about 5 to about 25 wt % of a polyphosphonate oligomer of the present invention. Masterbatches of polymer containing a polyphosphonate oligomer of this invention, which are blended with additional amounts of substrate polymer, typically contain even higher concentrations of the polyphosphonate oligomer of this invention, e.g., up to 50 wt % or more.

Any of several conventional additives used in thermoplastic formulations may be used, in their respective conventional amounts, with the oligomeric flame retardants of this invention, e.g., plasticizers, antioxidants, fillers, pigments, UV stabilizers, impact modifiers, etc.

Thermoplastic articles formed from formulations containing a thermoplastic polymer and an oligomeric product of this invention can be produced conventionally, e.g., by injection molding, extrusion molding, compression molding, and the like. Blow molding may also be appropriate in certain cases.

The following Examples are presented for purposes of illustration. They are not intended to impose limits upon the overall scope of this invention.

### Example 1

### Polyphosphonate Oligomer Formed from Diethylene Glycol and Bisphenol-A (6:1 Mole Ratio)

Diethylene glycol (31.8 g; 0.3 mole), bisphenol-A (11.4 g; 0.05 mole), and trimethyl phosphite (49.6 g; 0.4 mole) were charged to a reactor. The mixture was heated to 150° C. under air. A total of 20.7 g of methanol was then distilled from the reaction mixture. The temperature was reduced to 100° C. Additional trimethyl phosphite (5.5 g) was added. After heating for 5 hours at 150° C. ³¹P NMR showed that the phosphite had been totally converted to phosphonate. There was no need of catalyst for this Arbuzov type of rearrangement. A vacuum (5 mm) was applied to the reaction mixture at 120° C. for 1 hour to remove volatile components. The residual product was a colorless liquid with an acid value of 0.7 and a hydroxyl number of 12.4.

### Example 2

### Polyphosphonate Oligomer Formed from Diethylene Glycol and Bisphenol-A (6:1 Mole Ratio)

In a scale-up of the procedure of Example 1, diethylene glycol (572.4 g; 5.4 mole), bisphenol-A (205.2 g; 0.9 mole), and trimethyl phosphite (892.8 g; 7.2 mole) were charged to a reactor. The mixture was heated to and held at 150° C. for 7 hours under air. A total of 399.1 g of methanol was then distilled from the reaction mixture. ³¹P NMR showed that all phosphite had been converted to phosphonate. The reactor contents were vacuum distilled at 150° C./2 mm for 1 hour and purged with nitrogen at 90° C. for 30 minutes to provide a colorless viscous liquid with an acid value of 1.0 and a hydroxyl number 40. The viscosity of the product was 9,500 cps.

### Example 3

### Polyphosphonate Oligomer Formed from Diethylene Glycol and Bisphenol-A (5.8:0.2 Mole Ratio)

Diethylene glycol (30.7 g; 0.29 mol), bisphenol-A (2.3 g; 0.01 mole), and trimethyl phosphite (43.4 g; 0.35 mol) were charged to the reactor. The mixture was heated at 110° C. for 1 hour. The temperature was reduced to 90° C., and trimethyl phosphite (3.1 g) was added. The mixture was re-heated to 120° C. for another hour. Methanol (19.2 g) was collected. Benzyl chloride (12.1 g; 0.1 mole) was charged to the reaction mixture which was maintained at 120° C. for 1 hour. After continued heating at 120° C. for 2 more hours, the temperature was then reduced to 60° C. After adding methyl iodide (0.5 mL), the temperature was maintained at 120° C. for 3 hours. ³¹P NMR showed that all phosphite had been converted to phosphonate. After heating to 120° C. under 5 mm vacuum for 1 hour, this colorless liquid had an acid value of 1.1. This liquid product mixture was treated with 3 g of propylene oxide at 100° C. for 1 hour. The volatiles were distilled from the reaction mixture at 120° C./5 mm The remaining product was a colorless liquid with an acid value of 0.1 and a hydroxyl number of 41.6. The product had a viscosity of 4,970 cps.

### Example 4

### Polyphosphonate Oligomer Formed from Diethylene Glycol, Hexanediol, and Bisphenol-A (3:2:1 Mole Ratio)

Diethylene glycol (15.9 g; 0.15 mol), bisphenol-A (11.4 g; 0.05 mole), 1,6-hexanediol (11.8 g; 0.1 mole), and trimethyl phosphite (43.4 g; 0.35 mol) were charged to the reactor. The mixture was heated at 120° C. for 1 hour and then to 150° C. and maintained at 150° C. for 5 hours. The temperature was then lowered to 120° C. Methyl iodide (0.5 mL) was added, and the mixture was heated at 120° C. for 4 hours. Vacuum distillation at 5 mm and 120° C. for 2 hours was carried out to remove the more volatile components of the reaction mixture. The distillation left in the reactor a colorless viscous liquid product with acid value of 2.8 and hydroxyl number of 46.6. If desired, this product can be neutralized with an alkylene oxide such as propylene oxide.

### Example 5

### Polyphosphonate Oligomer Formed from Hexanediol and Bisphenol-A (5:1 Mole Ratio)

Bisphenol-A (125.4 g; 0.55 mole), 1,6-hexanediol (324.5 g; 2.75 mole), and trimethyl phosphite (477.4 g; 3.85 mole) were charged to the reactor. The mixture was heated to 125° C. gradually. A total of 218 g of methanol was collected as distillate. The temperature was then lowered to 85° C., and 1 mL of methyl iodide was added. The mixture was re-heated to 120 to 125° C. for 8 hours. Methyl iodide (0.5 mL) was added during the heating. A 5 mm vacuum was applied to the reaction mixture, which was maintained at 110 to 116° C. Propylene oxide (17 mL) was added to react between 100-110° C. for 1 hour. The resultant reaction mixture was subjected to vacuum distillation at 110° C./5 mm for 2 hours, and then was purged with nitrogen at 110° C. for 0.5 hour. The resultant product was a colorless viscous liquid. It had an acid number of 0.18, and a hydroxyl number of 42.5, and a viscosity of 10,000 cps.

### Example 6

### Polyphosphonate Oligomer Formed from Diethylene Glycol and Bisphenol-A (6:2 Mole Ratio)

Diethylene glycol (235.3 g; 2.22 mol), bisphenol-A (168.7 g; 0.74 mole), and triethyl phosphite (552.8 g; 3.33 mol) were charged to the reactor. The mixture was heated gradually to 150° C. and 198.5 g distillate was collected. The temperature was lowered to 130° C. After adding 15 g of triethyl phosphite, the mixture was heated at 150° C. for another 1 hour. Vacuum was applied at 110° C./50 mm A total of 249 g of distillate was collected. After lowering the temperature to 80° C., methyl iodide (2 mL) was added. The mixture was heated at 120 to 122° C. for 8 hours, and during this heating, 2.2 mL of methyl iodide was added to the product mixture. ³¹P NMR showed that all the phosphite had been converted to phosphonate. Vacuum was applied at 120° C./5 mm until 49.2 g of distillate was collected. The remaining mixture in the reactor was cooled to 60° C. Propylene oxide (5 mL) was added to the mixture in the reactor and the contents were heated to 100° C. for one hour. Application of a vacuum at 120° C./5 mm for one hour yielded as the pot residue a colorless liquid with acid value of <0.1 and a hydroxyl number of 82.

### Example 7

### Polyphosphonate Oligomer Formed from Diethylene Glycol and Bisphenol-A (6:2 Mole Ratio)

Diethylene glycol (267.1 g; 2.52 mole), bisphenol-A (191.5 g; 0.84 mole), and trimethyl phosphite (468.8 g; 3.78 mole) were charged to the reactor. The mixture was heated gradually to 150° C. and 194.4 g distillate was collected. After adding methyl iodide (0.25 mL), the mixture was heated at 150° C. for 1 hour. ³¹P NMR showed the conversion to phosphonate was complete. After vacuum had been applied at 110° C./5 mm for 2 hours, the liquid was purged with nitrogen at 110° C. for another 2 hours. This resulted in a liquid product having an acid value of 1.0 and a hydroxyl number of 58.9. After adding propylene oxide (4.0 g), the mixture was heated at 100 to 110° C. for one hour. Vacuum was applied at 115° C./5 mm 2 hours. This resulted in a colorless liquid with acid value of less than 0.1 and a hydroxyl number of 59. The product had a viscosity of 10300 cps.

### Example 8

### Polyphosphonate Oligomer Formed from Diethylene Glycol and Bisphenol-A (6:1 Mole Ratio)

Diethylene glycol (254.4 g; 2.4 mole), bisphenol-A (91.2 g; 0.4 mole), and triethyl phosphite (531.2 g; 3.2 mole) were charged to a reactor. The mixture was heated gradually to 135° C. and 192 g of distillate was collected. Vacuum was applied at 50 mm with heating at 70° C. to 85° C. A total of 237.5 g of distillate was collected. The mixture remaining in the reactor was cooled to ambient temperature and after adding 1 mL of methyl iodide, the mixture was heated to 120° C. Another 1.5 mL of methyl iodide was added during 6 hours of heating at 120° C. ³¹P NMR showed the conversion to phosphonate was complete. Propylene oxide (7.5 g) was added at 60° C. After heating at 100 to 110° C. for 2.5 hours, vacuum was applied at 120° C./5 mm for 30 minutes. This resulted in the reactor containing a colorless liquid product with an acid value of less than 0.1 mm and a hydroxyl number of 87.

### Example 9

### Polyphosphonate Oligomer Formed from Diethylene Glycol, Bisphenol-A, and Cyclohexanedimethanol (4:1:1 Mole Ratio)

Diethylene glycol (21.2 g; 0.2 mol), 1,4-cyclohexanedimethanol (7.2 g; 0.05 mole), bisphenol-A (11.4 g; 0.05 mole), and trimethyl phosphite (43.4 g; 0.35 mol) were charged to a reactor. The mixture was heated gradually to 140° C. and 18.4 g of distillate was collected. The temperature of the reactor contents was reduced to below 110° C., and trimethyl phosphite (4.2 g) was added. The resultant mixture was heated to 150° C. gradually for 6 hours. ³¹P NMR showed the conversion to phosphonate was complete. The mixture was then vacuum distilled at 125° C./5 mm for one hour. This left a colorless liquid having an acid value of 0.85 and a hydroxyl number of 44.8.

It is interesting to note from the above Examples that this invention makes it possible to provide oligomeric polyphosphonate flame retardants having viscosities of well over 4,000 cps at 25° C., even though a small proportion of an aromatic diol was used in forming the polyphosphonate. For example, polyphosphonates made solely from diethylene glycol were found to have viscosities in the range of about 900 to 950 cps at 25° C. On the other hand, as seen from Example 3, where a diethylene glycol bisphenol-A mole ratio of 5.8/0.2 was used, the viscosity of the resultant product at 25° C. was almost 5,000 cps.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

Each and every patent or publication referred to in any portion of this specification is incorporated in toto into this disclosure by reference, as if fully set forth herein.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text taken in context clearly indicates otherwise.

The invention may comprise, consist or consist essentially of the materials and/or procedures recited herein.

This invention is susceptible to considerable variation in its practice. Therefore the foregoing description is not intended to limit, and should not be construed as limiting, the invention to the particular exemplifications presented hereinabove.

1. An oligomeric organic phosphonate flame retardant comprised of at least one oligomeric organic phosphonate represented by the formula: 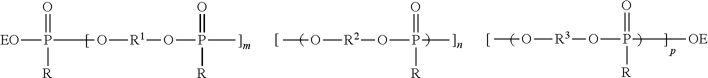
wherein:
each R can be the same or different and is a benzyl group or a C₁₋₄ primary or secondary alkyl group, and of the total number of R groups in the molecule, (i) each one is a benzyl group, or (ii) each one is a C₁₋₄ primary or secondary alkyl group, or (iii) at least one of them is a benzyl group and at least one of them is a C₁₋₄ primary or secondary alkyl group;
each R¹ can be the same or different, and is (i) an alkylene group having 2 to 6 carbon atoms, (ii) an alkyleneoxyalkylene group, in which each alkylene moiety contains, independently, 2 or 3 carbon atoms, or (iii) an alkyleneoxyalkyleneoxyalkylene group in which each alkylene moiety contains, independently, 2 or 3 carbon atoms;
each R² can be the same or different, and is (i) a 1,3-phenylene group, (ii) a 1,4-phenylene group, (iii) a -ph-O-ph- group in which ph is a 1,4-phenylene group, (iv) a -ph-O-ph-O-ph- group in which ph is a 1,4-phenylene group, (v) a -al-O-ph-O-al- group in which al is an ethylene group and ph is a 1,4-phenylene group, or (vi) a -ph-R⁴-ph- group in which each ph is a 1,4-phenylene group and R⁴ is a 2,2-propylidene group;
each R³ can be the same or different, and is (i) a -cy- group which is an unsubstituted cycloalkylene group containing five to eight carbon atoms in the ring, (ii) a -cy-alk- group in which cy is a cycloalkylene group, and alk is a methylene group, an ethylene group or a 1,3-propylene group, (iii) a -alk-cy-alk- group in which cy is a cycloalkylene group, and alk is a methylene or ethylene group;
m is an integer in the range of 0 to 5, n is an integer in the range of 0 to 5, and p is an integer in the range of 0 to 5, with the total of said integers m, n, and p being in the range of 3 to 10, and with the provisos that only one of m, n and p can be 0, and that neither m nor n nor p need be 0; and
each E is independently selected from HOR¹O—, HOR²O—, HO—R³O— or lower alkyl; and
wherein the bracketed segments of m, n, and p can be arranged in any order or sequence such that the oligomer has a random configuration, an alternating configuration, or a block configuration.

2. A flame retardant as in claim 1 wherein p is 0.

3. A flame retardant as in claim 1 wherein neither m nor n nor p is 0.

4. A flame retardant as in claim 1 wherein R¹ is an ethyleneoxyethylene group; wherein R² is a -ph-R⁴-ph- group in which each ph is a 1,4-phenylene group and R⁴ is a 2,2-propylidene group; and wherein p is 0 so that the flame retardant is polyphosphonate oligomer formed from diethylene glycol and bisphenol-A.

5. A flame retardant as in claim 1 wherein R¹ is an ethyleneoxyethylene group; wherein R² is a -ph-R⁴-ph- group in which each ph is a 1,4-phenylene group and R⁴ is a 2,2-propylidene group; and wherein R³ is -alk-cy-alk- in which each alk is CH₂, wherein cy is 1,4-cyclohexylene; and wherein neither m nor n nor p is 0 so that the flame retardant is polyphosphonate oligomer formed from diethylene glycol, bisphenol-A, and 1,4-cyclohexanedimethanol.

6. A flame retarded composition comprising at least one synthetic resin and at least one oligomeric organic phosphonate flame retardant of claim 1.

7. A formulation for forming a polyurethane foam upon introduction therein of a polymerization catalyst, which formulation comprises at least an isocyanate, a polyetherpolyol, a surfactant, a blowing agent, and a flame retarding amount of at least one oligomeric organic phosphonate flame retardant of claim 1.

8. A flame retarded polyurethane foam formed by introduction of a polymerization catalyst into a formulation of claim 7.

9. A process for producing a flame retardant polyurethane foam, which process comprises introducing a polymerization catalyst into a formulation of claim 7.

10. A process for producing at least one oligomeric organic phosphonate flame retardant of claim 1, which process comprises:
I) bringing together at least one tri-lower alkyl phosphite, and at least two dihydroxy compounds selected from:
A) aliphatic diols of the formula HO—R¹—OH in which each R¹ is (i) an alkylene group having 2 to 6 carbon atoms, (ii) an alkyleneoxyalkylene group, in which each alkylene moiety contains, independently, 2 or 3 carbon atoms, or (iii) an alkyleneoxyalkyleneoxyalkylene group in which each alkylene moiety contains, independently, 2 or 3 carbon atoms, and when more than one R¹-containing segment is present in the molecule the R¹ groups can be the same or different from each other;
B) diphenolic compounds of the formula HO—R²—OH in which R² is (i) a 1,3-phenylene group, (ii) a 1,4-phenylene group, (iii) a -ph-O-ph- group in which ph is a 1,4-phenylene group, (iv) a -ph-O-ph-O-ph- group in which ph is a 1,4-phenylene group, (v) a -al-O-ph-O-al- group in which al is an ethylene group and ph is a 1,4-phenylene group, or a (vi) a -ph-R⁴-ph- group in which each ph is a 1,4-phenylene group and R⁴ is a 2,2-propylidene group; and when more than one R²-containing segment is present in the molecule the R² groups can be the same or different from each other;
C) cycloaliphatic diols of the formula HO—R³—OH in which R³ is (i) a -cy- group in which cy is an unsubstituted cycloalkylene group, (ii) a -cy-al- group in which cy is a cycloalkylene group, and al is a methylene group, an ethylene group or a 1,3-propylene group, (iii) a -al-cy-al- group in which cy is a cycloalkylene group, and al is a methylene or ethylene group; and when more than one R³-containing segment is present in the molecule the R³ groups can be the same or different from each other to form a first reaction mixture, and heating the first reaction mixture at a temperature in the range of about 70 to about 150° C., and removing alkanol from the first reaction mixture to form a first reaction product mixture; and
II) bringing together first reaction product mixture and (a) at least one alkyl halide, (b) at least one benzyl halide, or (c) a combination of (a) and (b) to form a second reaction mixture, and heating the second reaction mixture at a temperature in the range of about 90 to about 160° C. to form at least one oligomeric organic phosphonate.

11. A process as in claim 10 wherein in A) only at least one reactant from (i) and only at least one reactant from (ii) are used.

12. A process as in claim 10 wherein in A) at least one reactant from (i), at least one reactant from (ii), and at least one reactant from (iii) are used.

13. A process as in claim 11 wherein in A) diethylene glycol and bisphenol-A are used.

14. A process as in claim 12 wherein in A) diethylene glycol, bisphenol-A, and cyclohexane dimethanol are used.
